(19) United States
(12) Patent Application Publication
(10) Pub. No.: US 2006/0258245 A1
(43) Pub. Date: Nov. 16, 2006

(54) Multilayered material part and formed part produced therefrom

(76) Inventors: Oliver Salzmann, Willich (DE); Guido Franzke, Sassenberg (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/430,802

(22) Filed: May 9, 2006

(30) Foreign Application Priority Data
May 10, 2005 (DE) 20 2005 007 647.3
Nov. 10, 2005 (DE) 10 2005 054 062.7
Dec. 23, 2005 (DE) 10 2005 062 353.0

(51) Int. Cl. B32B 5/02; B32B 5/24; B29C 35/08

(52) U.S. Cl. 442/221; 442/59; 442/370; 264/405

(57) ABSTRACT

The invention relates to a thermoformable, sheet-type material part (1) of multilayer structure having at least one thermoformable, sheet-type support (3) made of a thermoplastic material and at least one in particular flat textile material (4) which is associated to the support (3) and is laminated to the support (3), and also a formed part (6) produced therefrom by forming, which is suitable in particular for use in the furniture industry, in particular for production of seating furniture.

### CROSS REFERENCES TO RELATED APPLICATIONS

The present application claims priority to German Patent Application Serial No. DE 20 2005 007 647.3, filed May 10, 2005; German Patent Application Serial No. DE 10 2005 054 062.7, filed Nov. 10, 2005; and German patent Application Serial No. DE 10 2005 062 353.0, filed Dec. 23, 2005, all of which are hereby incorporated by reference in their entirety.

### BACKGROUND OF THE INVENTION

The present invention relates to a formable, in particular thermoformable, sheet-type material part and to a formed part producible therefrom which is suitable in particular for production of furniture. In addition, the present invention relates to the use of the formed part for production of furniture, in particular seating furniture, and also to furniture produced therewith as such. Finally, the present invention relates to a process for production of such a formed part.

With respect to the production of multilayered formed parts containing a thermoplastic component or layer, it is provided in the prior art that a formable material which is generally fashioned as a sheet-type, is first converted by means of suitable processes into the desired three-dimensional shape. In a subsequent step a further layer, for example a flat textile material or the like, can be applied or permanently fixed to the resultant three-dimensional formed part. In this case the flat textile material is fixed, for example, by means of adhesion or the like. A disadvantage in this case, however, is that the flat material is applied after forming, because this makes the adhesion more difficult, and that the high number of process steps is in one respect labor-intensive and costly. In particular, it is frequently impossible to bond the flat textile material over the whole surface to the formed material; this is because in particular in the region of intense deformations (e.g. in the case of intense bends, indentations and bulges and the like) intense strain and compression of the flat textile material occurs, which can frequently lead to detachment or delamination of the flat material. In addition, in the case of subsequent application of a flat textile material to the already formed material, frequently unwanted fold formation occurs. A further disadvantage in this process is that, owing to the subsequent fixing of the flat textile material to the three-dimensional structure, a nonuniform strain of the flat textile material can result which leads to an uneven surface profile. Finally, the high and uneven return forces due to the subsequent, occasionally non-uniform. “stretching” of the flat textile material onto the support structure can lead to subsequent deformation of the formed part.

In the Applicant's own DE 36 12 834 A1, a textile composite material is proposed which consists of a foam layer glued to a textile material. It is provided in this case to apply the textile material to the foam layer before the final shaping. However, it is a disadvantage in this case that the foam must firstly be given a skin or closed at the surface pores, in order to be able to carry out shaping at all. However, an occasionally low-load bearing and, owing to the elasticity of the foam, low-dimension stability composite results, which owing to the absence in principle of an additional support material is not suitable for high stresses, as are demanded in the context of self-supporting and mechanical load-bearing structures, in particular for seating furniture. In addition, the process described, owing to the skin coating of the foam which must be provided is time-consuming and costly, and also costly in terms of apparatus.

Against this technical background, the object of the present invention is still to provide a material part or a three-dimensional formed part producible therefrom which avoids the above-described disadvantages of the prior art at least in part or else reduces them. In particular, a material part having a multilayered structure is to be provided which comprises an in particular flat textile material on a support and which is to be suitable for forming into a dimensionally stable formed part which withstands high mechanical stresses. With respect to the formed part, intense bends, indentations and bulges and the like are to be able to be achieved without delamination or fold formation occurring with respect to the individual layers of the formed part. Finally, the resultant formed part is to be self-supporting and to a great extent dimensionally stable, so that it is suitable, in particular, for use in furniture, such as seating furniture.

To achieve the object described above, the present invention proposes a formable, in particular thermoformable, sheet-type material part (i.e. a material piece) having a multilayered structure as disclosed and claimed, and also a formed part obtainable by forming, in particular thermoforming, the inventive material part as disclosed and claimed. Further advantageous developments are subject matter of the respective sub-claims.

In addition, the present invention relates to the use of the inventive formed part for production of furniture, in particular seating furniture, and also to furniture, in particular seating furniture, per se. Finally, the present invention relates to a process for production of the inventive formed part as disclosed and claimed. Further advantageous developments of the inventive process are subject matter of the process sub-claims.

The present invention thus firstly relates to a formable, in particular thermoformable, sheet-type material part having a multilayered structure which is suitable in particular for production of formed parts, preferably for furniture, and has at least one formable, in particular thermoformable, sheet-type support which consists of a thermoplastic material. The inventive material part is distinguished, in particular, in that it has at least one in particular flat textile material associated to the support, which flat textile material is laminated to the support. Owing to this special design of the inventive material part, it is suitable, in particular, as starting material for production of three-dimensional formed parts which are a further subject matter of the present invention. In this case, it is possible, in particular, to achieve intense bends or deformations by means of customary forming processes, as a result of which individual shapes or structures which are adapted to the respective requirements, for example anatomical shaping with simultaneously high load-bearing capacity with respect to seating furniture, can be achieved.

The inventive material part or formed part is not restricted to the abovementioned two-layer structure. Rather, it is equally possible that, between the support and the flat material, in addition at least one flat intermediate layer is arranged, in which case this intermediate layer can be fashioned, in particular, as a foam layer. In this case, the flat material is laminated to the intermediate layer and the intermediate layer is in turn bonded to the support, in particular bonded in a two-dimensional manner, such that in this case a three-layer structure or a three-layer composite material results. In addition, as described in more detail hereinafter, the side facing away from the flat material can also be furnished with a further, in particular flat textile material, or a further intermediate layer, so that to an extent what is termed a “sandwich structure” results, in which the thermoplastic support so to speak forms the core layer of the layer or composite material.

The central concept of the present invention is, in particular, that first a material part is provided as already at least essentially prefabricated composite containing all components and this multilayered material part can then be subjected to a subsequent shaping process to obtain the inventive formed part. In other words, the present invention is distinguished in that already before the shaping step or during the shaping step, with the inventive material part, a stable composite material is present having layers which are bonded to one another permanently and in a two-dimensional manner, and consequently subsequent application of layers after the shaping process is avoided completely. As a result, it is made possible according to the invention to furnish the inventive formed part with regions which are formed particularly intensely and differently from one another, without, for example, the flat material applied to the support delaminating or forming folds. In addition, dimensionally stable self-supporting formed parts which can withstand high loads, as occur, in particular, in the use in connection with seating furniture, are involved within the context of the present invention owing to the preferred use of a to an extent solid thermoplastic support which is hard at service temperature and preferably non-foamed.

According to the invention, the term “sheet-type” (e.g. sheet-type material part) is taken to mean an at least essentially level or planar or flat shape, in particular of the inventive material part, the thickness of the material part being at least essentially constant over its surface. If desired in terms of application, the individual layers can also have different thicknesses, however, in a surface-specific manner, for example in order to achieve a further optimized anatomical shape in the case of seating furniture.

In the context of the present invention, the term “formable” (e.g. formable material part) is to be taken to mean that the inventive material part, retaining the mass of the layer assembly, can be converted at least essentially irreversibly into another shape or structure.

In this context, the term “thermoformable” (e.g. thermoformable material part) is to be taken to mean that, as described in more detail hereinafter, the inventive material part can be formed with heating, for example to a temperature range above the softening point of the thermoplastic support, in particular by means of thermoforming. Processes suitable for this are well known to those skilled in the art. For example, the thermoforming can proceed by means of vacuum forming, vacuum thermoforming and the like.

In addition, the term “three-dimensional” (three-dimensional shape or structure with respect to the inventive formed part) denotes a structure which has formed and spatial regions deviating from the level or planar structure, which encompass, for example, and in a non-limiting manner, indentations and bulges, recesses, bends and the like.

In addition, the term “dimensionally stable” (e.g. dimensionally stable material part or formed part) is to be taken to mean according to the invention that the inventive material part or formed part can withstand or absorb the loads resulting from the respective use, for example in the context of the production of seating furniture.

The expression “associated” (e.g. a flat material associated to the support) is to be taken to mean according to the invention that firstly the possibility exists that the flat material is laminated or fixed directly to the support, secondly, however, this term can also equally encompass indirect association of the flat material with respect to the support, in which case, for example, at least one further intermediate layer is arranged between the flat material and the support.

Finally, the term “laminating” (e.g. laminating the flat material to the support) is to be taken to mean an in particular flat bonding or adhesion of the respective layers of the inventive material part, the bonding of the individual layers being able to proceed, for example, by means of methods well known to those skilled in the art, in particular film-coating methods, generally by means of suitable laminating or film-coating agents, such as adhesives, hot-melt adhesives, hot-melt adhesive webs and the like. In this context the flat bonding or laminating or film-coating of the individual layers preferably proceeds over the entire surface, i.e. the film-coating agent is preferably applied continuously. Equally, however, discontinuous bonding is also possible, for example by means of point-form or raster-form application of the adhesive. According to a particular design, the respective layers of the inventive material part can be bonded to one another by flame-bonding processes known per se to those skilled in the art, in which case it should be ensured, in particular, that at least one layer has thermal adhesive properties.

Further advantages, features, properties and aspects of the present invention result from the description hereinafter of preferred embodiments with reference to the figures.

### BRIEF SUMMARY OF THE INVENTION

The invention relates to a formable, sheet-type material part (1) of multilayer structure having at least one formable, sheet-type support (3) made of a thermoplastic material and at least one in particular flat textile material (4) which is associated to the support (3) and is laminated to the support (3), and also a formed part (6) produced therefrom by forming, which is suitable in particular for use in the furniture industry.

One object of the present invention is to provide an improved process for production of furniture.

Related objects and advantages of the present invention will be apparent from the following description.

### BRIEF DESCRIPTION OF THE SEVERAL VIEWS OF THE DRAWINGS

FIG. 1A shows a diagrammatic cross section of a material part according to one embodiment of the present invention.

FIG. 1B shows a diagrammatic cross section of a material part according to an alternative embodiment of the present invention.

FIG. 2 shows a diagrammatic representation of a formed part formed from a material part according to the FIG. 1B structure.

FIG. 3A shows a diagrammatic representation of an article seating furniture which is produced using a formed part according to the present invention.

FIG. 3B shows a diagrammatic representation of another article of seating furniture which is produced using a formed part according to the present invention.

FIG. 4 shows a diagrammatic representation of a process sequence in which a material part is formed into a formed part according to the present invention.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

In the figures, the same reference signs are used for identical or similar parts, corresponding properties and advantages being achieved, even when a repeated description is omitted for the sake of simplification.

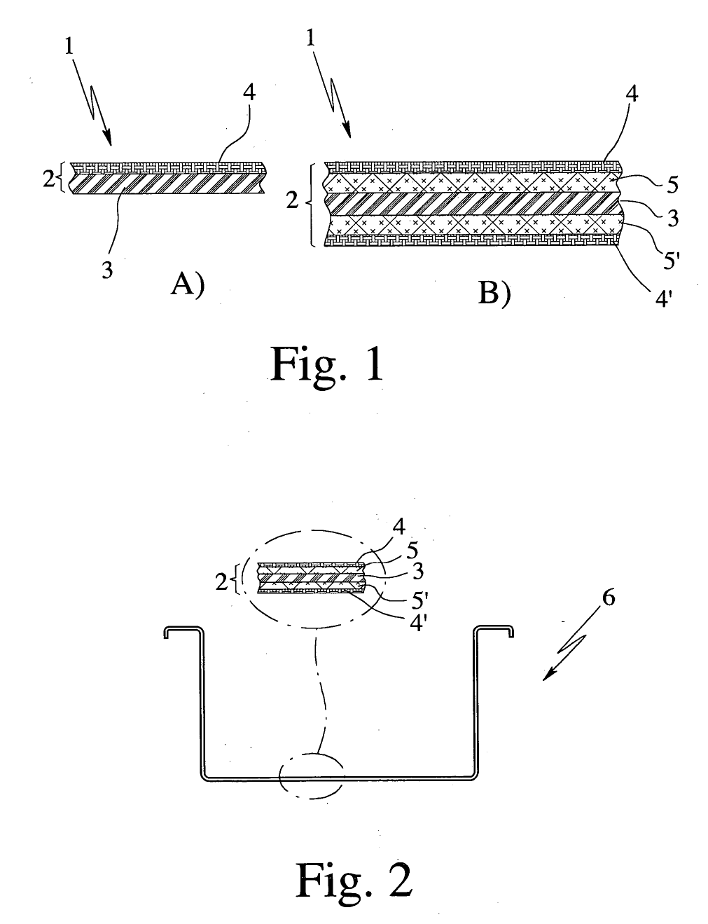

FIG. 1A shows a formable, in particular thermoformable, sheet-type material part 1 according to the invention having a multilayered structure 2, in particular for production of formed parts 6, preferably for furniture, the material part 1 having at least one formable, in particular thermoformable, sheet-type support 3, the support 3 consisting of a thermoplastic material. The material part 1 has at least one, in particular flat textile material 4 associated to the support 3, the flat material 4 being laminated to the support 3.

FIG. 1A thus shows a composite or a layer material formed in one piece, consisting of two layers, that is a flat material 4 firstly and a thermoplastic support 3 secondly.

As explained above, the present invention, however, is in no way restricted to this embodiment. Thus it is in addition possible as shown in FIG. 1B by way of example, that at least one in particular flat intermediate layer 5 can be arranged between the support 3 and the flat material 4; the intermediate layer 5 is preferably a foam layer further described hereinafter. According to the embodiment of FIG. 1B, the flat material is laminated to the intermediate layer 5 in a manner described above, and the intermediate layer 5 is bonded to the support 3 in particular in a two-dimensional manner. According to this embodiment, a three-layer material thus results, which, however, just as the material part 1 described in FIG. 1A is fashioned in the manner of a composite material. In this respect, the bonding of the intermediate layer 5 to the support 3 can proceed, for example, by lamination or film-coating (e.g. by adhesion etc.). Alternatively, the intermediate layer 5 can be bonded to the support 3 by flaming. It is equally possible that the flat material 4 and/or the intermediate layer 5 and/or the support 3 is or are designed to be thermally adhesive, so that a permanent bond can proceed by corresponding heating and joining of the respective layers.

In other words, the present invention relates to a formable, in particular thermoformable, sheet-type material part 1 having a multilayered structure 2, in particular for production of formed parts 6, preferably for furniture, the material part 1 having at least one formable, in particular thermoformable, sheet-type support 3, the support 3 consisting of a thermoplastic material. The material part 1 has at least one in particular flat textile material 4 associated to the support 3 and, arranged between the support 3 and the flat material 4, at least one flat intermediate layer 5, in particular a foam layer. The flat material 4 is, according to this embodiment, as illustrated by way of example in FIG. 1B, laminated to the intermediate layer 5 and the intermediate layer 5 is bonded to the support 3, in particular bonded in a two-dimensional manner.

In the scope of the present invention, it is equally possible that the intermediate layer 5 in turn comprises a plurality of individual layers which can, for example, consist of different foam materials, so that a multilayered structure 2 having more than three layers can also result.

As far as the dimensioning of the layers is concerned, the flat material 4, the support 3, and also if appropriate the intermediate layer 5 can have the same dimensions in terms of area, so that the layers are to an extent arranged congruently in the inventive material part. In this case it can be provided that the edge regions of the layers 3, 4, 5 are not laminated, so that the edge regions of the flat material 4 and/or the intermediate layer 5 can to an extent be folded down or up from the support 3. According to a further inventive embodiment, the flat material 4 and/or the intermediate layer 5 is or are dimensioned to be smaller in terms of area than the support 3, so that the support 3 then, to an extent, extends over at least one edge of the flat material 4 and/or the support 5. As described hereinafter, such an inventive material part 1 can be formed in a special manner.

As described above, the present invention is distinguished in that an at least essentially finished or prefabricated material part 1 is provided which already has all of the components or layers of the finished end product (for example the seat shell of an article of seating furniture) and which, in this already finished construction, is formable into a formed part 6. Thus, after completion of the end product 6, for example subsequent coating or impinging steps are obviated which, as described above, frequently do not lead to satisfactory results.

As concerns the support 3, this is preferably a thermoplastic which is hard at service temperature, in particular at room temperature (25° C.) and atmospheric pressure. Thus the support 3 should, at room temperature (25° C.) and atmospheric pressure, be at least dimensionally stable or self-supporting. In particular, the thermoplastic support 3 should be configured such that after the forming process to produce the inventive formed part 6 has been carried out, the return forces possibly occurring due to the in particular flat textile material 4 or the intermediate layer 5 where present lead at least essentially to no shape change of the formed part 6 or the support 3.

The support 3 is preferably fashioned to be non-porous or non-foamed. In other words, the support 3, according to an inventively particularly preferred embodiment, is solid or cavity-free as such. By this means, a particularly good shape stability and mechanical stability of the material part 1 is achieved. Equally, the non-porous structure of the support 3 makes it possible for the resultant material part 1 to be formed without problems, for example by means of vacuum forming processes to give the three-dimensional formed part 6, without a preceding skin coating of the support 3 needing to be performed.

In the context of the present invention, the material of the support 3 can be selected from polymers or copolymers. In this respect, preferably polyolefins, vinyl polymers, polyamides, polyesters, polycarbonates and polyurethanes come into consideration. According to an inventively preferred embodiment, the material of the support 3 comprises polyolefins, in particular polyethylene or polypropylene, particularly preferably polypropylene copolymers, or else acrylonitrile/butadiene/styrene copolymers (ABS copolymers). For further details with respect to thermoplastics, reference may be made to Römpp Chemielexikon [Römpp's chemistry lexicon], 10th Edition, Volume 6, 1999, Georg Thieme Verlag, Stuttgart, N.Y., pages 4505/4506, head word: “thermoplastics”, the contents of which, including the literature references cited there, are hereby incorporated herein in their entirety by reference.

Equally, in the context of the present invention, what are termed thermoplastic elastomers can also be used for the support 3, which have a combination of service properties of elastomers and the processing properties of thermoplastics. For further details in this respect, reference can equally be made to Römpp, Chemielexikon [Römpp's chemistry lexicon], 10th Edition, Volume 6, 1999, Georg Thieme Verlag, Stuttgart, N.Y., pages 4506/4507, head word: “thermoplastic elastomers”, the contents of which, including the literature references cited therein, are hereby incorporated herein by reference.

According to the invention, for the support 3, particularly preferably use is made of materials and thermoplastics which have a yield stress as specified in ISO 527 of 5 to 10 N/mm², preferably 10 to 45 N/mm², more preferably 15 to 40 N/mm², particularly preferably 20 to 35 N/mm². Equally, the material of the support 3 should have a yield strain as specified in ISO 527 of less than 20%, preferably less than 16%, more preferably less than 12%. The material of the support 3 should in addition have a tear strength as specified in ISO 527 of at least 15 N/mm², preferably at least 20 N/mm², more preferably at least 25 N/mm², and/or have an elongation at break as specified in ISO 527 of 5 to 700%, and have a modulus of elasticity as specified in the 4-point bending test according to ISO 178 of 500 to 2.200 N/mm², preferably 700 to 2.100 N/mm², more preferably 900 to 1.900 N/mm².

In addition as far as the material of the support 3 is concerned, this can be impact resistant without fracture at 23° C. (impact resistance according to Charpy as specified in EN ISO 179/1 eU), or can have an impact resistance according to Charpy as specified in EN ISO 179/1 eU at −30° C. of at least 40 kJ/m², preferably at least 50 kJ/m², more preferably at least 60 kJ/m², particularly preferably at least 70 kJ/m². In addition, the material of the support 3 can have a notched impact strength as specified in EN ISO 179/1 eA at 23° C. of at least 15 kJ/m², preferably at least 25 kJ/m², more preferably at least 35 kJ/m². Furthermore, the material of the support 3 can have a notched impact strength as specified in EN ISO 179/1 eA at −30° C. of at least 1 kJ/m², preferably at least 2 kJ/m², more preferably at least 3 kJ/m², and furthermore a ball indentation hardness (H358/30) as specified in EN ISO 2039-1 of at least 50 N/mm², preferably at least 60 N/mm², more preferably at least 70 N/mm². Finally, the material of the support 3 should have a density of 0.8 to 1.5 g/cm³, in particular 0.85 to 1.4 g/cm³, preferably 0.9 to 1.3 g/cm³. Finally, the material of the support 3 should have a Vicat softening temperature (VST A 120 or VST B 50) as specified in ISO 306 of 80° C. to 200° C., preferably 85° C. to 180° C., preferably 90° C. to 160° C.

Suitable materials for the support 3 are, for example, Metzo®Plast PP/C and Metzo®Plast ABS/M from Metzeler Plastics GmbH, Jülich, Germany.

The thickness of the support 3 can vary in a broad range. According to the invention, preferably, the support 3 can have a thickness of 1 mm to 20 mm, preferably 1.5 mm to 5 mm, more preferably 2 mm to 10 mm, particularly preferably 2.5 mm to 7 mm, very particularly preferably 3 mm to 5 mm. However, it is possible to deviate from these values in an application-specific manner, or due to individual cases, for example when the inventive material part 1 in the context of an inventive formed part 6 is to be used, for example, for production of particularly load-bearing furniture, in which case the thickness of the support can then markedly exceed 15 mm.

As far as the flat material 4 of the formable, in particular thermoformable, sheet-type material part 1 of the invention is concerned, this is preferably a flat textile material, and in particular a woven fabric, knits or scrim. According to an inventively particularly preferred embodiment, the flat material 4 is a woven fabric. In addition, it is, however, equally possible that, as flat material 4, use is made of, for example, a leather or an artificial leather. Equally, as flat material 4, film-like plastics and thin-walled metal films also come into consideration. In particular, the flat material 4 can be selected in such a manner that it is at least essentially lightproof.

The weight per unit area of the flat material 4 can vary in wide ranges. For instance the flat material 4 can have a weight per unit area of 25 to 600 g/m², in particular 50 to 500 g/m², preferably 100 to 400 g/m².

According to an inventively preferred embodiment, the flat material 4 is reversibly extensible and/or in particular bielastic, i.e. extensible in both directions, or highly elastic. In this case the flat material 4 can have an extensibility in at least one direction, preferably in longitudinal and transverse direction, of at least 5%, in particular at least 10%, preferably at least 20%, in order to be able to follow the changes in length and width possibly occurring during forming without tearing.

According to an inventively particularly preferred embodiment, as flat material 4, use is made of an in particular bielastic woven textile fabric which has, for example, an elasticity in the warp direction of about 35% or more and in the weft direction an elasticity of 20% or more. For the production of such a bielastic woven fabric, for example, and in a non-limiting manner, special elastic twists can be used as are described, for example, in the Applicant's own EP 0 036 948 A1, the contents of which are hereby incorporated herein in their entirety by reference. This concerns in particular an elastic twist in which an elastomeric thread of about 140 to 200 denier is adhesively twisted with two yarns, the thickness of each of which is about one-tenth of the elastomeric thread, with, as yarns, use preferably being made of OE yarns (“open end yarns”) produced in the rotor process from polyvinyl chloride, polyvinyl cyanide, polyacrylonitrile and/or wool threads. Equally, according to the invention use can be made of a bielastic woven fabric which is described in DE 28 57 498 C2, likewise the Applicant's own, the contents of which are hereby incorporated in their entirety by reference.

According to a particularly preferred embodiment, use can be made of a bielastic woven fabric which has a weight of 350 g/m² at an elasticity in the warp direction of at least 35%, and an elasticity in the weft direction of at least 20%. Such a fabric can, based on the total weight of the fabric, comprise, for example, about 4.8% Elastan®, about 89.3% polyester and about 5.9% polyamide. According to the invention, it is equally possible that the flat material 4 is in addition impregnated, coated or the like in order to finish the flat material 4, for example in a flame-retardant manner, or to increase the soil repellency.

According to the invention, the flat material 4 can be laminated to the support 3 by means of a laminating and/or film-coating agent, in particular by means of an adhesive. Preferably according to the invention, the adhesive is a hot-melt adhesive, or a hot-melt adhesive web. Adhesives which come into consideration are, in addition, plastic dispersions known as such to those skilled in the art, but also reactive adhesives, such as, in particular, polyurethane-based single- or two-component systems. Generally, the adhesive is applied in a two-dimensional manner, so that, for example, continuous adhesion, in particular as defined above, results. Equally, it is possible within the scope of the present invention to apply such a flat adhesion or lamination in which the laminating or film-coating agent is applied in point form or point-raster form, or discontinuously. It is equally possible that the flat material 4 and/or the support 3 are fashioned to be thermally adhesive.

As far as the intermediate layer 5 of the inventive material part 1 is concerned, this can be a foam, preferably based on polyolefins or polyurethanes, foams based on polyolefins being preferred according to the invention. Equally, according to the invention, use can also be made of a peroxide-crosslinkable polyethylene foam. The foam can equally be thermoformable, in which case the softening temperature should be selected in such a manner that the foam is not destroyed, or the foam is not too greatly compressed, on forming the inventive material part 1 to give the formed part 6 of the invention. The foam should at least be of a quality such that it, on account of its elasticity, in the context of production of the inventive formed part 6, can be brought into the desired shape with use of the inventive material part 1. This is because, preferably, the intermediate layer 5 and/or the flat material 4 is to an extent held in the resultant final shape by the support 3.

The intermediate layer 5, in particular the foam layer, can according to the invention preferably be a closed-pore or closed-cell foam which generally has a lower compressibility than open-pore foams and, on use of the inventive material part 1 or formed part 6, has an optimum elastic and reversible compressibility under load. For example, under stress in the case of a seating load (“sitting”) compression of the foam occurs, so that owing to the good matching to the user, a pleasant and comfortable seating feeling results, whereas after load (“standing up”) the foam is able to readopt its original thickness.

The intermediate layer 5, in particular the foam layer, can have a thickness of 1 mm to 50 mm, in particular 2 mm to 40 mm, preferably 3 mm to 30 mm, more preferably 4 mm to 25 mm, particularly preferably 5 mm to 20 mm, in which case the thickness, depending on the desired field of use, can vary in broad ranges and if appropriate can deviate from the specified ranges. As far as the bulk density of the intermediate layer 5, in particular the foam layer, is concerned, this can be 5 to 250 kg/m², in particular 10 to 150 kg/m³, preferably 20 to 100 kg/m³, preferably 25 to 95 kg/m³.

As far as the intermediate layer 5 is concerned, this can be, as described above, a foam layer or a layer made of a foamed material. The foam material used in this respect can have a tensile strength in the transverse and/or longitudinal direction as specified in ISO 1926 of 100 to 1.500 kPa, in particular 150 to 1.300 kPa, preferably 100 to 1.100 kPa; in other words the material of the intermediate layer 5, in particular the foam material, should have a tensile strength as specified in the abovementioned standard in the longitudinal and/or transverse direction of at least 100 kPa, in particular at least 150 kPa, preferably at least 200 kPa.

In addition, the foam material for the intermediate layer 5 should have an elongation at break in the longitudinal or transverse direction as specified in ISO 1926 of 50 to 350%, in particular 65 to 325%, preferably 80 to 300%; in other words the foam material for the intermediate layer 5 should thus have an elongation at break as specified in the abovementioned standard in the longitudinal or transverse direction of at least 50%, in particular at least 65%, preferably at least 80%. As far as the compressive strength as specified in ISO 844 of the foam material for the intermediate layer 5 is concerned, this should be, for a compression of 10%, at least 5 kPa, in particular at least 10 kPa, preferably at least 15 kPa, at a compression of 25%, at least 25 kPa, in particular at least 30 kPa, preferably at least 35 kPa, at a compression of 50%, at least 85 kPa, in particular at least 90 kPa, preferably at least 95 kPa. As far as the compressive deformation resistance as specified in ISO 1856/C for a loading of 22 hours and a compression of 25% at 23° C. is concerned, the foam material of the intermediate layer 5 should, 0.5 hours after release, have a compressive deformation resistance of at most 30%, in particular at most 25%, preferably at most 20%, and 24 hours after release, a value of at most 20%, in particular at most 15%, preferably at most 10%. Finally, the foam material for the intermediate layer 5 should have a μ value as specified in ISO 1663 at 0 to 85% relative humidity and 23° C. of 3,000 to 20,000, in particular 3,500 to 19,000, preferably 4,000 to 18,000.

According to the invention, for the intermediate layer 5, use can preferably be made of the foams marketed under the trade names Alveolit® and Alveolen® marketed by Alveo AG, Lucern, Switzerland, which are particularly suitable for thermoforming, and in particular for vacuum forming (i.e. vacuum thermoforming).

As shown in FIG. 1B, it can equally be provided according to the invention that the support 3 has, on the side facing away from the flat material 4, at least one in particular flat textile material 4′ associated to the support 3, in particular the flat material 4′ being laminated to the support 3. In addition, it can be provided according to the invention that, on the side facing away from the flat material 4 between the support 3 and the flat material 4′, a flat intermediate layer 5′, in particular foam layer, is arranged. For this case, the flat material 4′ can be laminated to the intermediate layer 5′ and the intermediate layer 5′ can be in particular bonded in a two-dimensional manner to the support 3. According to this inventive embodiment, a composite or sandwich structure thus results, in which the support 3 is to an extent the core layer, on which further layers are applied on both sides. In this case, in principle, for the flat material 4 or for the intermediate layer 5, identical or different materials can be used for the flat material 4′ or for the intermediate layer 5′. As far as fixing the intermediate layer 5′ or the flat material 4′ is concerned, reference can be made to the above statements relating to the flat material 4 or the intermediate layer 5, which apply in this respect mutatis mutandis.

In addition, the present invention, according to a second aspect of the present invention, relates to a formed part 6 shown by way of example in FIG. 2, in particular for the production of furniture, such as seating furniture and the like, which is obtainable or produced by forming, in particular thermoforming, of at least one material part 1, in particular as described above. As stated above, the formed part 6 can thus be produced by thermoforming, such as vacuum forming, vacuum thermoforming and the like, in which case by forming under heating (“thermoforming”), a three-dimensional structuring proceeds in relation to the formed part 6, in particular to give this a technical or mechanical function, static properties, stabilization and the like. To achieve or improve these properties, it can be provided that the inventive formed part 6 is in addition bonded by further bonding systems, or integration with other bonding systems is achieved. For instance, adhesion of at least two inventive formed parts 6 or to material parts 1 can be provided.

A central particularity of the inventive formed part 6 which is obtainable by forming the material part 1 of the invention is considered to be that the flat material 4 associated to the support 3 of the material part 1 is laminated to the support 3 before the forming or during the forming of the material part 1 to give the formed part 6. As far as the above-described three-layer structure or multilayer structure of the material part 1 is concerned, a further particularity of the present invention is considered to be that the formed part 6 can have an intermediate layer 5, in particular foam layer, arranged between the support 3 and the flat material 4 of the material part 1, which intermediate layer is likewise bonded to the support 3, in particular in a two-dimensional manner, before the forming or during the forming, with in this case the flat material 4 being laminated to the intermediate layer 5 before the forming or during the forming. In other words, the inventive formed part 6 is based on a material part 1 of the present invention which already has before forming all of the layers of the formed inventive formed part 6, the individual layers being able to be bonded to one another before forming or during forming into the inventive formed part 6, so that subsequent application of layers after forming has been completed is not required according to the invention.

Therefore, as stated above, with respect to the inventive formed part 6, a particularly highly pronounced three-dimensional shape or structure can be achieved. The fact that the individual layers in principle are combined before or during forming of the material part 1 to give the formed part 6 also applies to the optionally provided intermediate layer 5′ and the likewise optionally provided flat material 4′. In total this results in a formed part 6 which, without further working steps, has a final sight area or surface.

In other words, the present invention therefore relates to a formed part 6 which can be used in particular for the production of furniture, such as seating furniture and the like, the formed part 6 having a three-dimensional shape or structure, in particular bulges, recesses, dents, bends or the like, the formed part 6 having a multilayered structure 2 having a support 3 made of a thermoplastic material and an in particular flat textile material 4 associated to the support 3, the flat material 4 being laminated to the support 3.

In addition, the present invention, according to the second aspect of the present invention, alternatively relates to a formed part 6, in particular for the production of furniture, such as seating furniture and the like, the formed part 6 having a three-dimensional shape or structure, in particular as defined above, the formed part 6 having a multilayered structure 2 having a support 3 made of a thermoplastic material and an in particular flat textile material 4 associated to the support 3 and a flat intermediate layer 5, in particular foam layer, arranged between the support 3 and the flat material 4, the flat material 4 being laminated to the intermediate layer 5 and the intermediate layer 5 being bonded to the support 3. In this respect, the above statements on the inventive material part 1 also apply, mutatis mutandis, to the inventive formed part 6.

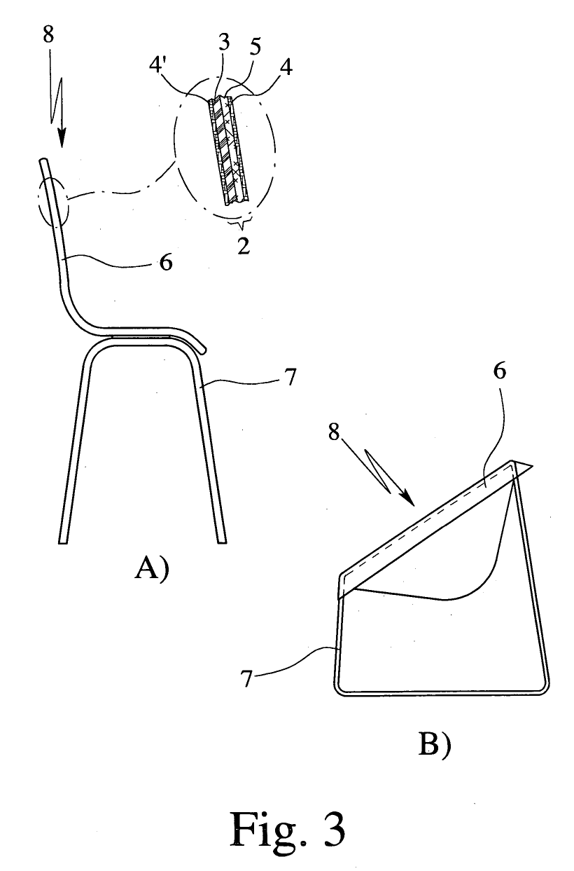

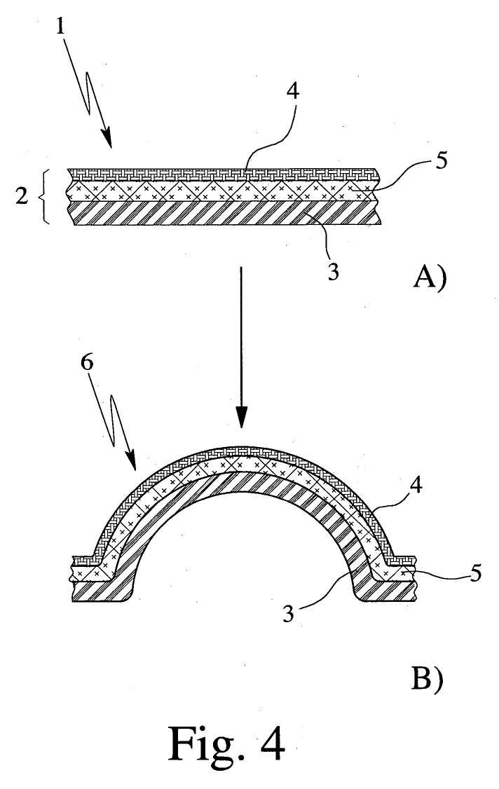

As far as the inventive formed part 6 is concerned, this can to an extent be present in a final form suitable for the respective application, in particular for furniture 8, such as seating furniture, e.g. according to FIG. 3A and FIG. 3B, for example as flat or formed element of an underside or backside of a seat part or back part or as complete seat shell of an article of seating furniture, in which case the inventive formed .part 6 can be additionally equipped with static elements 7 (i.e. supports, holders, connection elements, rods, chair legs etc.).

As far as equipping the inventive formed part 6 with additional static elements 7 is concerned, after forming is completed, holders or fixing points for the abovementioned elements 7 can be introduced, for example by means of boreholes.

According to a particular embodiment, the inventive formed part 6 can be fashioned in such a manner that it has a thermoplastic acting as core, which thermoplastic is coated on one side with a special foam, for example Trocellen® and a substance, while the side facing away from the special foam and substance comprises a first layer of a foam or gel which in turn is impinged with a special foam, for example Trocellen®, which in turn is coated with a substance. This thus results in a structure having the following layer structure: substance/special foam/thermoplastic/foam (gel)/special foam/substance.

In addition, the present invention, according to a third aspect of the present invention, 15 relates to the use of the inventive formed part 6, in particular as defined above, for production of furnishing articles or furniture, in particular seating furniture 8, as shown by way of example in FIGS. 3A and 3B. In principle, the furnishing articles can be used for the purposes of interior design to an extent as interior and also for purposes of exterior design to an extent as exterior.

In the scope of the present invention, the term “seating furniture” is to be understood very widely: for instance the term “seating furniture” relates to seating opportunities or seating elements of all types, such as, for example and in a non-limiting manner, benches, chairs, armchairs, sofas, three-piece suites, stools and the like. The seating furniture can be arranged in such a manner that it consists of a formed part 6 or has at least one formed part 6.

According to the invention, the formed part 6 can make up certain units of the seating furniture 8, such as, for example, a one-piece seat/back part (“seat shell”). Alternatively, for example two formed parts 6 bonded to one another in a manner known per se to those skilled in the art can each make up the front side and back side of a seat/back part or a seat shell. Equally, it is within the scope of the present invention when the formed part 6 makes up the front and/or back side of a seat part and/or the front and/or back side of a back part of an article of seating furniture 8. In this case the formed parts 6 respectively used for the corresponding front side and back side can be fashioned differently; for example the formed part 6 which makes up the front side of a seat part and/or back part of an article of seating furniture 8, to increase the seating comfort, can have a thicker foam layer or intermediate layer 5 than the corresponding formed part 6 for the back side. According to the invention, the term “front side” means the side of the article of seating furniture which faces the user of the seating furniture, while the term “back side” relates to the side facing away from the user of the seating furniture in the use state.

In addition, it is also possible that the inventive formed part 6 makes up further elements of the article of seating furniture 8, for example rests, leg or calf rests in the case of armchairs, headrests and the like. Within the scope of the present invention, it is equally possible to use the inventive material part 1 without further forming for seating furniture, for example for fashioning back and/or seat regions or the like.

In addition, the inventive formed part 6 can also be used, for example, for saddles, in particular bicycle saddles and the like, in particular since the inventive formed part 6 can have, e.g., intense bends or shaped regions, so that the saddle produced from the inventive formed part 6 can be adapted without problems to the anatomy of the user. A further field of use of the inventive formed part 6 is, for example, its use for seating furniture in public transport since, owing to the above-described specific layer structure having the flat lamination, a high dirt resistance results, since soiling cannot penetrate deep into the material, and secondly, owing to the fixed adhesion of the individual layers, a high protective function against damage, for example as a result of vandalism, results, since the two-dimensionally laminated, in particular flat textile material 4 is to an extent stabilized by the underlying layer, so that as a result it has a certain cutting resistance, or resistance e.g. to penetration.

In addition, the inventive formed part 6 can be used as decorative element, for example in the form of cable claddings, partitions, covers and the like. In principle, the inventive formed part 6 can be used for purposes of interior design, to an extent as interior and for purposes of exterior design, to an extent as exterior.

According to a further, fourth aspect of the present invention, the present invention equally relates to furniture, in particular seating furniture 8, which have at least one formed part 6 of the present invention, in particular as defined above, or at least one material part 1 of the present invention, in particular as defined above.

FIGS. 3A and B show in an illustrative manner, and in a non-restricting manner, two inventive articles of seating furniture 8, which are fashioned as chairs. According to FIG. 3A, the inventive formed part 6 makes up a uniform seat and back part, with the inventive formed part 6 used in this respect being produced from an inventive material part 1 by forming and, as illustrated by the detail enlargement of FIG. 3A, has a layer structure 2 having a core layer made of a thermoformable thermoplastic support 3, on which, in particular to increase the seating comfort on the front side, an intermediate layer 5 of a foam material is laminated, to which, in turn, a flat textile material 4 is applied. On the side of the support 3 facing away from the flat textile material 4 and the intermediate layer 5, a further flat textile material 4′ is laminated, in particular for decorative purposes; this side makes up the back side of the seat/back part of the article of seating furniture 8. To enhance the optical appearance, the edge of the formed part 6 can be furnished, for example, with a profiled strip (not shown).

The formed part 6 can have an attachment or connection region (not shown), to which, for example, further static elements 7, such as a support unit or “chair legs”, can be attached. In this respect, the attachment sections, on production of the inventive material part 1 or its formation to give the inventive formed part 6, can to an extent be coformed, so that they are themselves fashioned by the inventive material part 1 or the inventive formed part 6.

FIG. 3B shows the side view of a further inventive chair 8 which is constructed as an armchair, in which case the inventive formed part 6 is fashioned in such a manner that at its edge or “rest region” an indentation or recess for receiving a support element 7, which can be, for example, an appropriately bent steel tube, results.

Finally, the invention further relates, according to a fifth aspect of the present invention, to a process for production of a formed part 6, in particular for the production of furniture, such as seating furniture and the like, which comprises the following process steps:
a) providing a formable, in particular thermoformable, sheet-type material part 1, in particular as defined above, having a multilayered structure 2, having a formable, in particular thermoformable sheet-type support 3 made of a thermoplastic material and an in particular flat textile material 4 associated to the support 3, and if appropriate a flat intermediate layer 5 arranged between the support 3 and the flat material 4; subsequently
b) forming the material part 1 to obtain the formed part 6 having a three-dimensional shape or structure, in particular bulges, recesses, dents, bends or the like.

In other words, a process is provided for production of a formed part 6 as described above, which is suitable in particular for the production of furniture, such as seating furniture and the like, in which a material part 1 as described above is formed using forming methods which are known per se to give the corresponding formed part 6, as described above.

As far as forming the material part 1 to obtain the formed part 6 is concerned, use can be made of forming processes which are known per se to those skilled in the art, with, in this respect, these being in particular what are termed thermoforming processes (“thermoforming”). For this, use can be made of, for example, processes known per se to those skilled in the art, such as thermoforming, vacuum forming, vacuum thermoforming and the like, the material part 1 being heated before and/or during the forming (“thermoforming”), in particular above the softening temperature of the support 3. In the scope of the present invention, the corresponding forming process is used against the background of giving the inventive material part 1 a three-dimensional shape or structure to obtain the inventive formed part 6, so that the resultant formed part 6 can adopt static or technical functions. As far as the respective forming processes used for this purpose are concerned, those skilled in the art are always able to select these appropriately and to modify them appropriately with respect to the material part to be formed.

In the context of thermoforming, for example first the material part 1 can be heated to a forming or softening temperature, for example by means of radiant heating or contact heating or in hot air, so that the material part 1 softens and thus becomes formable. Subsequently, the material part 1 can be formed, for example, by means of thermoforming, which is what is termed a tensile force forming process, to give the desired formed part 6. Thermoforming can be carried out, for example and in a non-limiting manner, by means of a stamp or by means of a top mould and counter mould (dies). The latter leads to smaller dimension tolerances.

In addition, the thermoforming can proceed by means of vacuum forming, which is likewise well known to those skilled in the art. In this respect the material part can be clamped air-tightly, for example using a clamping frame, and then be heated, for example, by means of infrared radiators, and stretched over a solid mould, or stretched or compressed by means of vacuum and/or pressure into a solid mould, in which case the mould can be fashioned as a negative or positive mould. After cooling and hardening, the formed part can then be removed from the mould.

The inventive process is distinguished in that the flat material 4, before process steps a) and b) are carried out, or else during the forming in process step b) is laminated to the support 3. In other words, an already at least essentially prefabricated material 1 having a multilayered structure or layer structure 2 is subjected to a subsequent forming procedure or forming process. In this case it is possible according to the invention to fashion the layer structure 2 before forming, or else during forming, i.e. the respective layers 3, 4, 5 are, in the latter case, bonded to one another, preferably laminated, in particular in a two-dimensional manner, during forming. Thus the material part 1 used for the forming already has all of the layers of the formed part 6 resulting therefrom after forming. By means of the forming process, therefore, to an extent “only” essentially the shape of the material part 1 is changed or the layer structure 2 is reinforced by bonding, in particular laminating, of the corresponding layers 3, 4, 5. By means of the special inventive measure that the flat material 4 is laminated to the support 3 before or while the process steps a) and b) are being carried out, it is accordingly possible to produce intense bends with respect to the resultant formed material without delamination and without folding of the flat material 3 or of the optional intermediate layer 5.

The flat material 4 can thus be laminated to the support 3 during the forming in process step b). As a result, the flat material 4 on forming, is freely movable to an extent with respect to the support 3 on its surface, and thus so to speak shiftable on the support 3, so that the respective layers can slide on one another. In this case it is within the scope of the present invention when the flat material 4 is bonded to the support 3, in particular prelaminated, at a few sites via individual, in particular circular or point-form fixing sections, in order to prevent delamination before forming.

According to the invention it can be provided according to a preferred embodiment that the flat material 4 is laminated to the support 3 by means of an adhesive, in particular a hot-melt adhesive, preferably a hot-melt adhesive web.

Equally, it is possible within the scope of the inventive process that, before the process steps a) and b) are carried out, or else before the forming in process step b), a flat intermediate layer 5, in particular foam layer, is arranged between the support 3 and the flat material 4. In this case, the flat material 4 can be laminated to the intermediate layer 5 and the intermediate layer 5 can be bonded to the support 3, in particular in a two-dimensional manner. The bonding of the support 3 to the intermediate layer 5, or of the intermediate layer 5 to the flat material 4, can be carried out in a previously described manner. The flat bonding of the intermediate layer 5 to the support 3 and laminating the flat material 4 to the intermediate layer 5 before or while process steps a) and/or b) are carried out leads to the abovementioned advantages, such as achieving large bends, avoiding folding and delamination. This assumes, in particular, a certain elasticity of the individual components or layers 3 and 5.

In the production of the workpiece 1 used for the formed part 6, it is possible to proceed in principle in such a manner that first the optional intermediate layer 5 is applied to the support 3 and bonded to this in a two-dimensional manner, for example by means of the above-described laminating or film-coating processes (e.g. rolling on, impressing, calendering and the like), and subsequently the flat material 4 is laminated to the intermediate layer 5. Equally, it is also possible that the intermediate layer 5 and the flat material 4 are applied simultaneously. If, on the side facing away from the intermediate layer 5 and the flat material 4, a further intermediate layer 5′ or a flat material 4′ is provided, these can also be applied simultaneously or in succession.

According to an alternative embodiment, the flat material 4 can be laminated to the intermediate layer 5 during the forming in process step b). In this respect, the intermediate layer 5 can be bonded to the support 3 during the forming in process step b), in particular bonded in a two-dimensional manner, preferably laminated. This is because it has completely surprisingly been found that particularly good forming results may be achieved if during the shaping process or forming the individual layers, in particular the flat material 4 and/or the intermediate layer 5 are to an extent freely movable with respect to the support 3 and thus so to speak is or are freely shiftable on the support 3, so that the respective layers can slide on one another. This is because as a result during the forming, a “continued flowing” or “continued sliding” of the flat material 4 or the intermediate layer 5 is made possible, which prevents individual layers, in particular the flat material 4 and/or the intermediate layer 5, from being exposed on forming to excessive stress due to extension and/or compression. In this manner, fold formation, delamination and/or crack formation or tearing is or are counteracted.

In addition, it is within the scope of the present invention when the entire layer composite 2 or else individual layers are bonded to one another during forming. In this respect the layers can be treated in advance with a laminating or film-coating agent. Equally, individual layers can be bonded to one another, in particular by means of lamination, even before forming (e.g. flat material 4 and intermediate layer 5 or intermediate layer 5 and support 3). On forming, the laminates are then permanently bonded, in particular laminated to the remaining layer.

According to a further embodiment, the support 3, the flat material 4 and if appropriate the intermediate layer 5 can be laminated at least in part before the process steps a) and b) are carried out, in particular, during the forming in process step b), the forming temperature being selected in such a manner that in the case of lamination using a laminating or film-coating agent, the laminating or film-coating agent, in particular the adhesive, preferably hot-melt adhesive, particularly preferably the hot-melt adhesive web, is brought into a liquid, in particular viscous, or thermally adhesive state. Alternatively, in the case of lamination without laminating or film-coating agent, at least one surface of the support 3 and/or of the flat textile material 4 and/or if appropriate of the intermediate layer 5 can become thermally adhesive, so that on forming in process step b), the layers 3, 4, 5 are shiftable with respect to one another. This is because in the case of this inventive embodiment also, the individual layers, in particular the flat material 4 and/or the intermediate layer 5 are to an extent freely movable on forming with respect to the support 3 and thus so to speak are freely shiftable on the support 3, so that during the forming, a “continued flowing” or “continued sliding” of the flat material 4 or the intermediate layer 5 is made possible and fold formation, delamination or tearing is counteracted.

In addition it has completely surprisingly been found that, using an inventive material part 1 in which the flat material 4 and/or the intermediate layer 5 is or are dimensioned to be smaller in area terms than the support 3, so that the support 3 then to an extent extends over at least one edge of the flat material 4 and/or the support 5, particularly good forming properties result. Customarily, for purposes of forming the material part 1, use is made of a frame or clamping frame known per se for forming purposes to those skilled in the art to receive the material part 1, with the material part 1, in particular, at its edge regions, being fixed or clamped. In particular, the frame serves for holding and/or prestretching or pretensioning the material part 1. Surprisingly, it has now been found that particularly good results with respect to forming the material part 1 may be achieved when the flat material 4 and/or the intermediate layer 5 is not held or fixed by the (clamping) frame. This can be achieved firstly by the smaller dimensioning of the flat material 4 and/or of the intermediate layer 5 in comparison with the support 3, or else by the above-described non-lamination of the edge regions of the layer structure 2 or else by a lower pressing force of the frame with respect to the material part 1. As a result of the non-holding of the edge regions of the flat material 4 and/or of the intermediate layer 5, during forming of the material part 1, a particularly good “continued flowing” or “continued sliding” of the flat material 4 and/or the intermediate layer 5 is achieved.

As stated previously the process step b) can be carried out by means of shaping processes known per se to those skilled in the art, in particular thermoforming, preferably also vacuum forming, vacuum thermoforming and the like. Finally, it can also be provided in the scope of the inventive process that the material part 1 in process step a) or the formed part 6 in or after process step b) is additionally equipped with at least one static element. In this case, e.g. static elements, such as profiles and the like, can be incorporated and integrated into the shape, which leads, for example, to a targeted increase in stability. In this respect, reference can be made to the above statements relating to the inventive formed part 6.

The inventive material part or formed part, and also the furniture produced therefrom and also the process for producing the inventive formed part have numerous advantages, of which the following are to be mentioned purely by way of example:
Owing to the special layer structure having a thermoplastic and preferably solid support, the inventive material parts or formed parts have a high stability, so that they are usable for numerous applications, for example for use in or as seating furniture. In this case, owing to the individual design of the individual layers, high variation and influence of the respective product properties is possible, with simultaneously high attractiveness and individual configurability of the surface (covering material).
Owing to the inventive principle according to which the in particular flat textile material and/or the intermediate layer is or are laminated to the thermoplastic support before forming or during the forming of the material part, and to an extent prefabricated product is subjected to the forming process, as a result of which highly pronounced forming and consequently individualized design of the formed part can be achieved, without adverse phenomena such as delamination and fold formation occurring. In addition, numerous different shapes can be achieved, so that the inventive formed part can be used in wide areas.
Development of the layer structure even before or during the forming makes it possible to bond all layers over the entire surface in the finished formed part, which cannot be achieved in the case of subsequent lamination in the region of intense bulges and curves.
The resultant formed parts are to a great extent resistant to soiling and damage, so that they are suitable, in particular, for use in or as seat units, e.g. in public transport.
Production of the inventive material part or formed part comprises a small number of process steps, which makes this a highly economical production process.

Further designs, modifications and variations of the present invention are easily recognizable and realizable on reading the description by those skilled in the art without departing from the scope of the present invention.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A thermoformable sheet-type material part having a multilayered structure and being appropriate for the production of formed parts for furniture, the material part having at least one thermoformable sheet-type support, the support consisting of a thermoplastic material, wherein the material part has at least one flat textile material associated to the support, the flat material being laminated to the support.

2. The thermoformable sheet-type material part according to claim 1, wherein, between the support and the flat material, an intermediate layer in the form of a foam layer is arranged, the flat material being laminated to the intermediate layer and the intermediate layer being bonded to the support.

3. A thermoformable sheet-type material part having a multilayered structure and being appropriate for the production of formed parts for furniture, the material part having at least one thermoformable sheet-type support, the support comprising a thermoplastic material, wherein the material part has at least one flat textile material associated to the support and a flat intermediate layer arranged between the support and the flat material, the flat material being laminated to the intermediate layer and the intermediate layer being bonded to the support.

4. The thermoformable sheet-type material part according to claim 3, wherein the support is a thermoplastic which is hard at room temperature (25° C.) and atmospheric pressure and wherein the support is dimensionally stable and self-supporting at room temperature (25° C.) and atmospheric pressure.

5. The thermoformable sheet-type material part according to claim 3, wherein the support is fashioned to be non-porous and non-foamed and wherein the flat material and the intermediate layer are dimensioned to be smaller in area terms than the support.

6. The thermoformable sheet-type material part according to claim 3, wherein the flat material is reversibly extensible, having an extensibility in at least one direction of at least 5%.

7. The thermoformable sheet-type material part according to claim 3, wherein the flat material is laminated to the support or the intermediate layer by means of a laminating or film-coating agent on an adhesive basis.

8. The thermoformable sheet-type material part according to claim 3, wherein the intermediate layer is a foam material based on polyolefins or polyurethanes.

9. The thermoformable sheet-type material part according to claim 3, wherein the intermediate layer is a closed-pore or closed-cell foam material.

10. The thermoformable sheet-type material part according to claim 3, wherein the support has, on the side facing away from the flat material, at least one flat textile material associated to the support, the flat material being laminated to the support.

11. The thermoformable sheet-type material part according to claim 3, wherein the support has, on the side facing away from the flat material, at least one flat textile material associated to the support, wherein between the support and the flat material a flat intermediate foam layer is arranged, the flat material being laminated to the intermediate layer and the intermediate layer being bonded to the support.

12. A formed part for the production of furniture, said formed part being produced by forming or thermoforming the thermoformable sheet-type material part according to claim 1.

13. The formed part according to claim 12, wherein the flat material associated to the support of the material part is laminated to the support before the forming or during the forming of the material part to give the formed part.

14. The formed part according to claim 12, wherein the intermediate foam layer arranged between the support and the flat material of the material part, before the forming or during the forming, is bonded to the support and wherein the flat material, before the forming or during the forming, is laminated to the intermediate layer.

15. The formed part according to claim 12, wherein the formed part has a three-dimensional shape or structure, the formed part having a multilayered structure having a support made of a thermoplastic material and a flat textile material associated to the support, the flat material being laminated to the support.

16. The formed part according to claim 12, wherein the formed part has a three-dimensional shape or structure, the formed part having a multilayered structure having a support made of a thermoplastic material and an in particular flat textile material associated to the support and a flat intermediate foam layer arranged between the support and the flat material, the flat material being laminated to the intermediate layer and the intermediate layer being bonded to the support.

17. A process for production of a formed part, said process comprising the following process steps:
a) providing a thermoformable sheet-type material part having a multilayered structure having a thermoformable sheet-type support made of a thermoplastic material and a flat textile material associated to the support, and optionally a flat intermediate layer arranged between the support and the flat material;
b) forming the material part to obtain a formed part having a three-dimensional shape or structure.

18. The process according to claim 17, wherein the flat textile material, before process steps a) and b) are carried out or during the forming in process step b), is laminated to the support.

19. The process according to claim 17, wherein the flat material is laminated to the support by means of a laminating or film-coating agent.

20. The process according to claim 17, wherein, before the process steps a) and b) are carried out, a flat intermediate foam layer is arranged between the support and the flat material, wherein the flat material, before the process steps a) and b) are carried out or during the forming in process step b), is laminated to the intermediate layer and the intermediate layer is bonded to the support.

21. The process according to claim 17, wherein the forming in process step b) is carried out using a shaping process by means of thermoforming, vacuum forming or vacuum thermoforming.
